(19) United States
(12) Patent Application Publication
(10) Pub. No.: US 2002/0129345 A1
(43) Pub. Date: Sep. 12, 2002

(54) Scripting business logic in a distributed object oriented environment

(76) Inventors: Mark D. Tilden, Portland, OR (US); Scott D. Hopkins, Aloha, OR (US); Brett J. Stonier, Hillsboro, OR (US)

Correspondence Address: STOEL RIVES LLP, 900 SW FIFTH AVENUE, SUITE 2600, PORTLAND, OR, 97204, US

(21) Appl. No.: 09/966,903

(22) Filed: Sep. 27, 2001

Related U.S. Application Data
(60) Provisional application No. 60/235,618, filed on Sep. 27, 2000.

(51) Int. Cl. G06F 9/44

(52) U.S. Cl. 717/162

(57) ABSTRACT

The software system of the present invention is a distributed object oriented software system that it is customizable and flexible enough to implement a wide variety of different “business logics” without the need to rewrite the basic components of the software system because it provides scripting capability in a distributed object-oriented software system. The present invention includes a rules-based scripting language that can be interpreted by a Rules Engine that is part of the base class of component for the software system. In accordance with the present invention each individual component of the software system may have one or more predetermined rule sets defined for it. Each predetermined rule set allows customization of the behavior of the associated component of the software system.

### RELATED APPLICATIONS

This application is a continuation of U.S. Provisional Patent Application No. 60/235,618 filed Sep. 27, 2000 and incorporated herein by reference.

### TECHNICAL FIELD

The present application relates to a rules based scripting system and method for use in a distributed object oriented environment.

### BACKGROUND OF THE INVENTION

A software system that is designed to perform according to a set of predetermined performance requirements needs to offer a flexibile approach to modifications when the performance requirements of the software system may differ from one installation to the next. Each installation of the software system will typically have its own unique “business logic”, or a set of predetermined performance requirements that may take the form of rules and guidelines as to how any processes within the software system should run. The unique business logic that typically accompanies an installation of the software system may differ from an applicable industry standard or from an industrywide average to some degree.

Typcially, control over individual components within the software system can be accomplished through the use of configuration parameters set in an appropriate section of a component server's configuration files. This technique can be used to turn a specific feature of the individual component on or off, and typically can also provide other necessary information to the component. For example, the general implementation of a converter component that performs a predetermined action on a second component requires that certain information be provided to the converter component, such as the name of the second component on which it should perform the conversion, as well as the location where the converter component can find and load the second component. The converter component can typically also accept various optional parameters, such as the specification of any number of attribute columns, which instruct the converter component to load a particular column of data from a database and provide access to the particular column of data to other components through an interface on the converter component.

While using configuration parameters, as described above, is a useful and necessary mechanism, it is entirely specific to an individual component and a given situation. In addition, the individual component must be coded to handle every aspect of the controlling parameters. Typically, using configuration parameters makes it difficult to provide the ability to reorder steps in a process, or change the process flow based on runtime decisions, or plug in customized special handling of specific situations without rewriting the entire component.

The need remains for a scripting approach to implementing customized performance of software components in a distributed objected-oriented software system.

### SUMMARY OF THE INVENTION

The software system of the present invention is a distributed object oriented software system that it is customizable and flexible enough to implement a wide variety of different “business logics” without the need to rewrite the basic components of the software system because it provides scripting capability in a distributed object-oriented software system. The present invention includes a rules-based scripting language typically designed to capitalize on the capabilities offered by a GenericServer XML configuration file approach, as shown and described in pending U.S. patent application Ser. No. 09/676,045, incorporated by reference herein.

In accordance with the present invention each individual component of the software system may have one or more predetermined rule sets defined for it. If any component does not have a predetermined rule set defined for it then the component will run according to its own internal program. If a single predetermined rule set is listed, and the component is built to process a predetermined rule set through a Rules Engine in accordance with the present invention, then the single predetermined rule set will be used for every call to the component's general purpose operation (e.g. Controller's do_operation, Modifier's modify, Validator's validate, etc.). If a plurality of predetermined rule sets is listed for a particular component, then that component will make a controllable runtime decision as to which predetermined rule set of the plurality of predetermined rule sets will be applied, usually by attempting to match the name of each predetermined rule set of the plurality of predetermined rule sets to a special instructions parameter passed in to the component when it was instantiated and using whichever predetermined rule set of the plurality of predetermined rule sets corresponds to the special instruction parameter.

The Rules Engine in accordance with the present invention is a standalone object, that has a kickoff functionthat a component calls whenever it needs to process a predetermined rule set. The Rules Engine exists as a member variable of the SnSComponent_i base component class for the software system. A component that does no rules processing has no need for the SnSRulesEngine and should not call it.

Once a component calls the Rules Engine, the Rules Engine drives the process of performing the rules, i.e. making calls back into the component to perform some of the individual rules. Typically, a rule set parameter controls which predetermined rule set to apply. If the rule set parameter is left blank when the component is instantiated, then the Rules Engine will attempt to select a predetermined rule set from the plurality of predetermined rule sets. Typically a rule label specifies which rule to run. If the rule label is left blank, all rules in the predetermined rule set are processed. Typically, a special instructions parameter is passed along to any callback functions, which is one way to provide controlling instructions to those operations.

Additional aspects and advantages of this invention will be apparent from the following detailed description of preferred embodiments thereof, which proceeds with reference to the accompanying drawings.

### BRIEF DESCRIPTION OF THE DRAWINGS

FIG. 1 is a high-level block diagram of a multi-tiered, distributed computing system to implement a robust, flexible, scalable, high-performance system for connecting end-users, via the internet, to a back-end resource such as a computerized reservation system.

FIG. 2 is a conceptual diagram of a generic container for loading software components based on a configuration file according to the present invention.

FIG. 3 is a conceptual diagram illustrating a configuration file specifying connections between components.

FIGS. 4A and 4B together form an example of a configuration file implemented in XML for a city code lookup process.

FIGS. 5A-5C illustrate software processes, each of which implements a generic container having a corresponding configuration file.

FIG. 6 is a simplified diagram illustrating operation of a multi-tiered, distributed computing system to support a travel planning and reservation web site.

FIG. 7 is a diagram of the elements of a software component including a Rules Engine, a set of function that can be performed by the component and the interactions of the component with a session state document.

FIG. 8 shows the typical structure of a video chain having a centralized data processing center and a plurality of video stores each of which interact with data processing center.

FIG. 9 shows a CustomerModifier component of a middle ware solution for the video chain of FIG. 8.

FIG. 10 is a block diagram showing a local computer at one of the video stores.

FIG. 11A and 11B is a configuration file for the RouteController component of FIG. 10, written in XML syntax.

FIG. 12 shows the details of the data processing center and the RouteController component in greater detail, along with interactions between the data processing center and the RouteController component of FIGS. 8-10.

FIG. 13 is a configuration file for a FrequentRentalModifier component of FIG. 12.

FIG. 14 is a configuration file for a GatewayIF component of FIG. 12.

FIG. 15 is a configuration file for a CustomerModifier component of FIG. 12.

### DETAILED DESCRIPTION OF PREFERRED EMBODIMENT

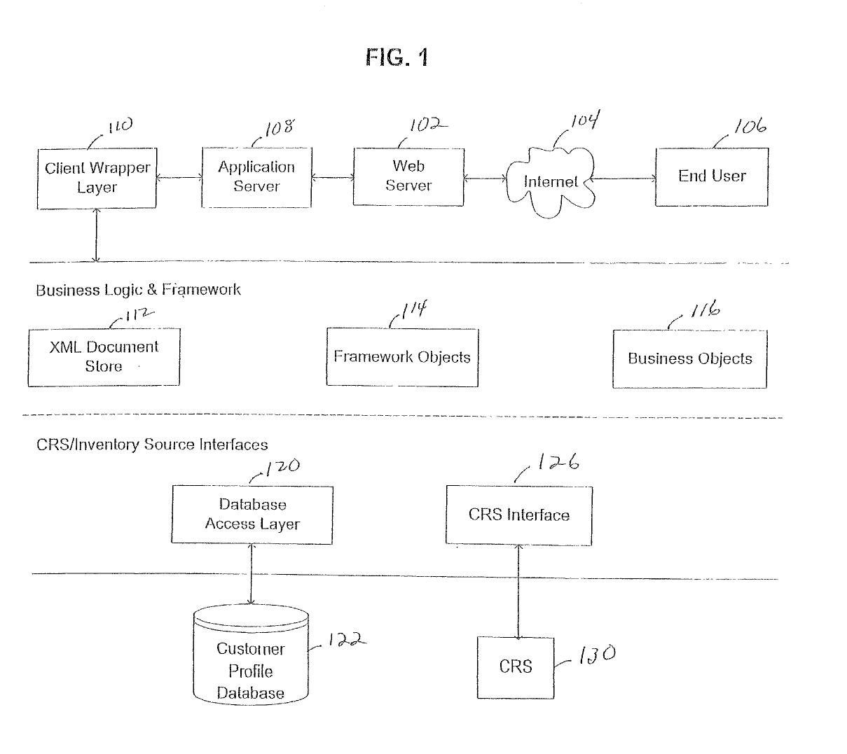

FIG. 1 illustrates a three-tiered e-commerce architecture with CORBA providing the distribution mechanism. In the top tier, an HTTP server 102 is coupled to the Internet 104 to provide access to multiple end-users 106 running standard Web browsers, such as IE or Navigator. Behind the Web server 102 is an application server, such as BroadVision application server 108. The application server interacts with the business logic and framework “middleware” through a client wrapper layer 110 provided by the middleware vendor. The client wrapper layer can be implemented, for example, using javascript and provides methods appropriate to the application, in this case air travel, hotel reservations and car rental. The client wrapper does not implement business logic. Business logic is implemented at the framework (middleware) level and at the user interface level via java scripts.

The second, intermediate tier implements the business logic and middleware framework of the present invention. This tier includes an XML document store 112, framework objects 114, business objects 116 and various interfaces for interfacing with computer reservation systems and/or inventory sources. By way of illustration, FIG. 1 shows a database access layer 120 for connection to a customer profile database 122 and it further shows a CRS (Computer Reservation System) interface 126 for interfacing to a computer reservation system 130. This drawing is highly simplified; for example, various of the framework objects 114 and business objects 116 may include factories for creating multiple instances of corresponding objects, and these various objects will be distributed in most applications across multiple servers. As noted above, a central theme of the present invention is to implement a middleware framework that greatly simplifies a deployment of business objects 116 without exposing the system source code. The business logic that drives the site includes such things as ticketing rules or restrictions on a particular itinerary. Business logic components can implement policies for pricing, discounts, seat assignments, etc. In one example, described later, a kosher meals object confirms the availability of kosher meals when requested. The CRS interface 126 in a practical implementation is likely to manage on the order of 1,000 simultaneous connections with CRSmainframes such as the SABRE System.

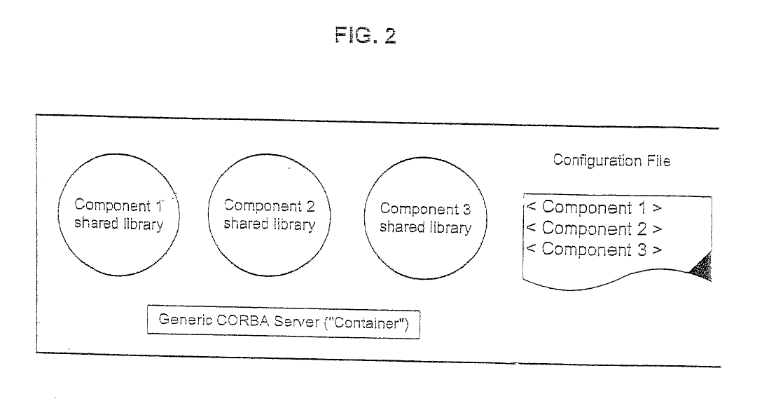

FIG. 2 illustrates a generic server container according to the present invention as mentioned in the summary above. Components are implemented by deriving from a framework base class. The programmer (or travel site integrater) implements desired functionality in the component objects and loads the resulting objects into the container by adding them to the container's configuration file 202 in FIG. 2. The components are implemented as shared libraries, so the container 204 can load them at run time without recompiling or linking the generic server container. The configuration files, expressed in XML syntax, are the basis for specifying which components the generic server should load, and how they should be connected together.

When the generic server starts up, one of the first things it does is look for a configuration file based on a name passed on the command line for the server. There is a separate configuration file for each server process in the preferred embodiment, as well as a shared configuration file that the separate configuration files can include. This makes it easy to put common elements, such as certain shared object references in the shared file where every server can use the information.

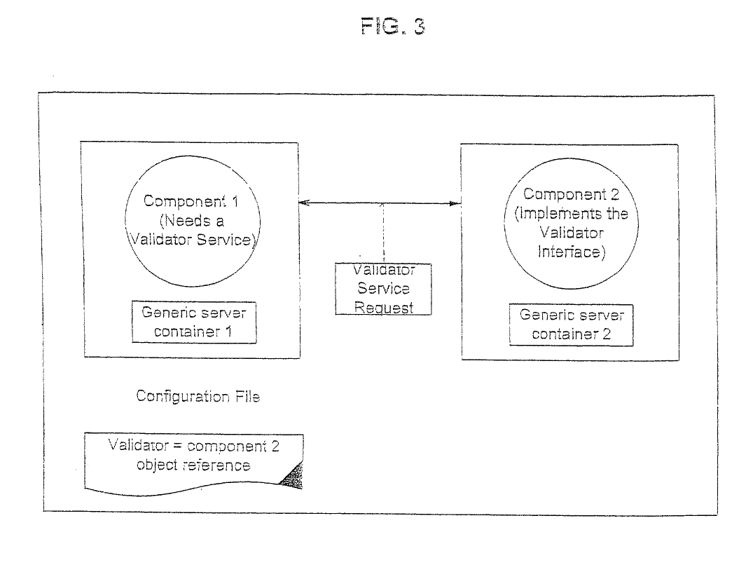

In addition, the configuration file can specify connections between components that implement specific framework-defined interfaces. The connections can include components that are located within the same server process (internal components), components located in other generic server processes, and even objects located in other processes not implemented within the framework (external components). Any CORBA object whose object reference can be entered in the configuration file in string form can be connected—even if the object is written in another language supported by CORBA. FIG. 3 illustrates a connection between two components as specified in a configuration file. In this case, component 1 requires a validator service, and a connection is provided in the configuration file to component 2, which implements the validator interface, and happens to be located in another server, identified by the component 2 object reference listed in the configuration file.

Threading Policies

The generic server also supports three different threading models for handling requests for the objects it contains.

1. Single Threaded. This is the simplest model. Each request coming into the generic server for any object contained in that server process is handled serially. Incoming requests are stored in a queue and each request executes to completion before the next request is handled. Notice that this model applies to all the components contained in a server process, so only one request for any component in the server process is handled at a time.

2. Thread per Request. The generic server container also supports a model where each incoming request is handled by a separate thread. Each new request causes a thread to be created to handle that request, and the thread executes until the request is completed. Then the thread terminates. A parameter specified in the XML configuration file can set the maximum number of threads to be created. If this maximum is reached, new requests are blocked until at least one previous request finishes and its thread terminates.

3. Pool of Threads. In this model, the generic server starts a number of threads specified in the configuration file at startup. Incoming requests are assigned a thread from the pool of available threads. If no threads are available when a request comes in, the request waits in the queue until a thread becomes available. The threading model used is specified by the configuration file. However, it can also be changed at run time. The generic server also checks the thread-safe attribute of each component it loads and forces the single threaded model if any of the components it is loading are not thread-safe. In addition, the generic server container handles thread maintenance issues, such as handling dead or hung threads, and reporting statistics on thread usage.

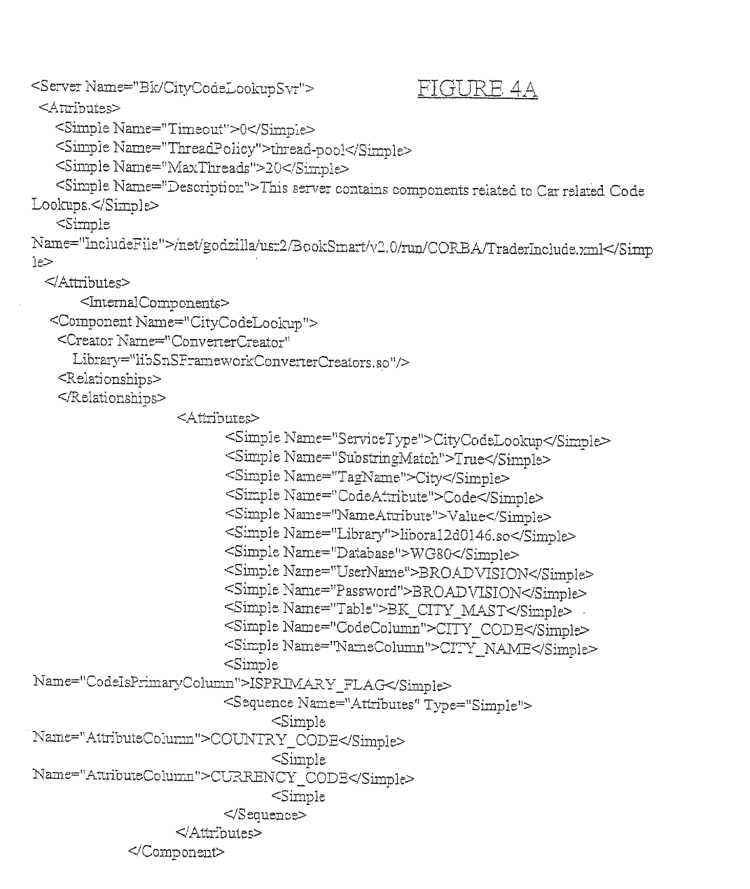

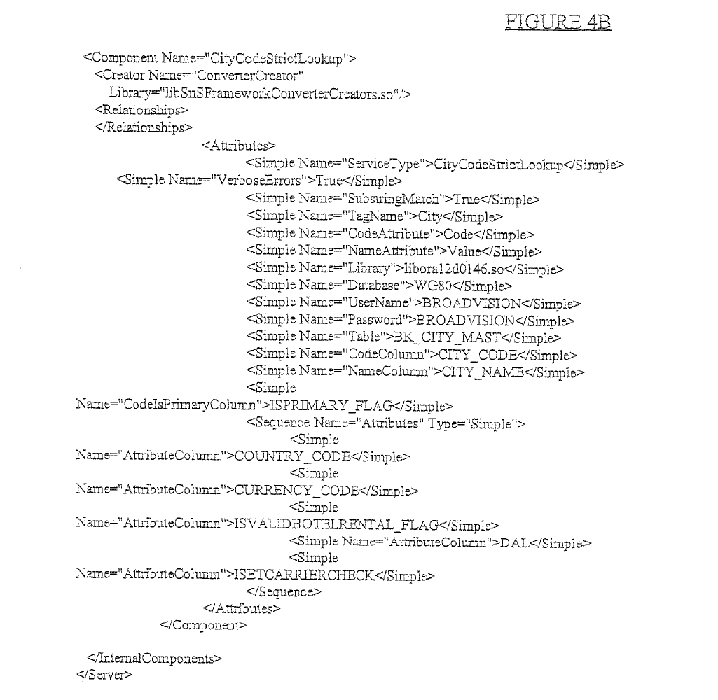

FIGS. 4A and 4B illustrate a configuration file, in this case, for a server identified as the city code lookup server. This provides a city code lookup capability which is made available to the application server through the client wrapper layer of FIG. 1. So, for example, if an end-user of the travel Web site enters a city name which is not unique (Portland, Oreg./Portland, Me.) or uses an airport abbreviation (PDX) or misspells the city name, the application server can call on the city code lookup to obtain one or more valid alternatives. Referring to FIG. 4A, the first portion of this file lists attributes of the container, such as time out, thread policy and maximum number of concurrent threads (“MaxThreads”).

<InternalComponents>

Internal software components are listed in this section, in this case, beginning with the component name “CityCodeLookup”. For each internal component, the configuration file indicates a creator name and location, relationships (in this example there are none) and attributes. In presently preferred embodiment, a component can have three types of attributes: simple, structure and sequence. In this example, all of the listed attributes are of the simple type.

The CityCodeLookup configuration file continues on FIG. 4B. Here, the next component is listed beginning with the component name “CityCodeStrictLookup.” Once again, a creator name was provided and a location of the creator, i.e., a library. There are no relationships in this example, and again various attributes are listed. Accordingly, when the CityCodeLookup server or container process initializes, it will read this configuration file, establishing the general attributes as noted, and then it will load (create) instances of the CityCodeLookup and CityCodeStrictLookup components. The simple-type attributes, and their corresponding values, provide the means for passing parameters to these components. This enables the integrated to change the parameters for a given business logic component simply by editing the XML configuration file.

Also, the configuration file defines the order of calling components simply by the order in which they appear in the configuration file. This allows new business logic (a new component) to be inserted at the correct point in an existing process simply by inserting it at the corresponding point in the component list in the configuration file. As further explained later, the configuration file can define relationships or “connections” between components; for example, defining which components use what other component's services. By “sequencing” a new component into the configuration file list at the correct location, in defining relations to other components, a new logic component can be fit into the overall system without changing any existing source code. Put another way, the present component container architecture presents a higher level of abstraction beyond, but still compatible with the CORBA infrastructure.

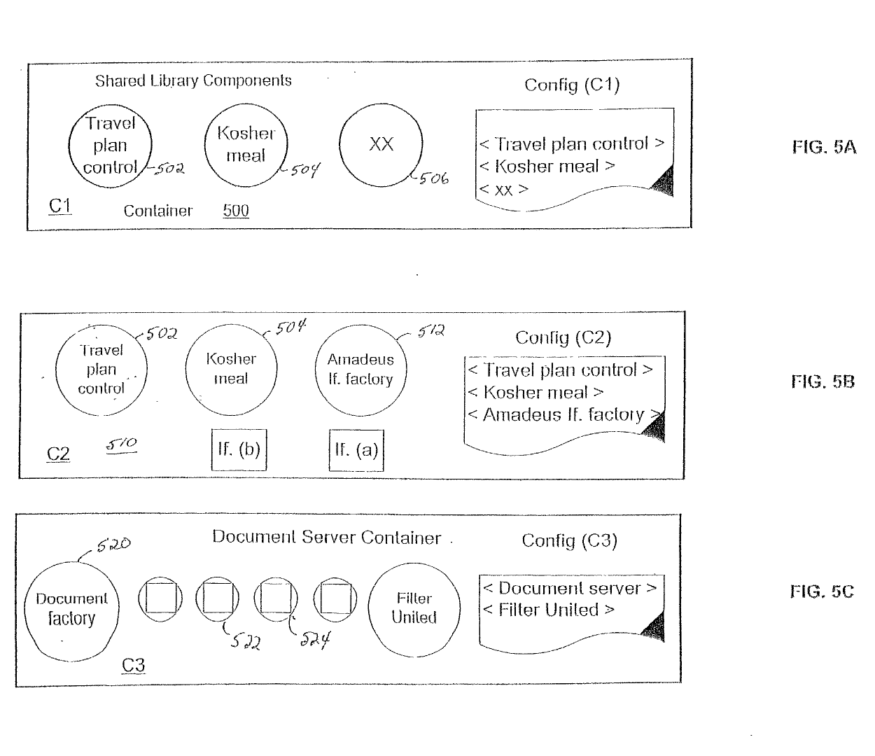

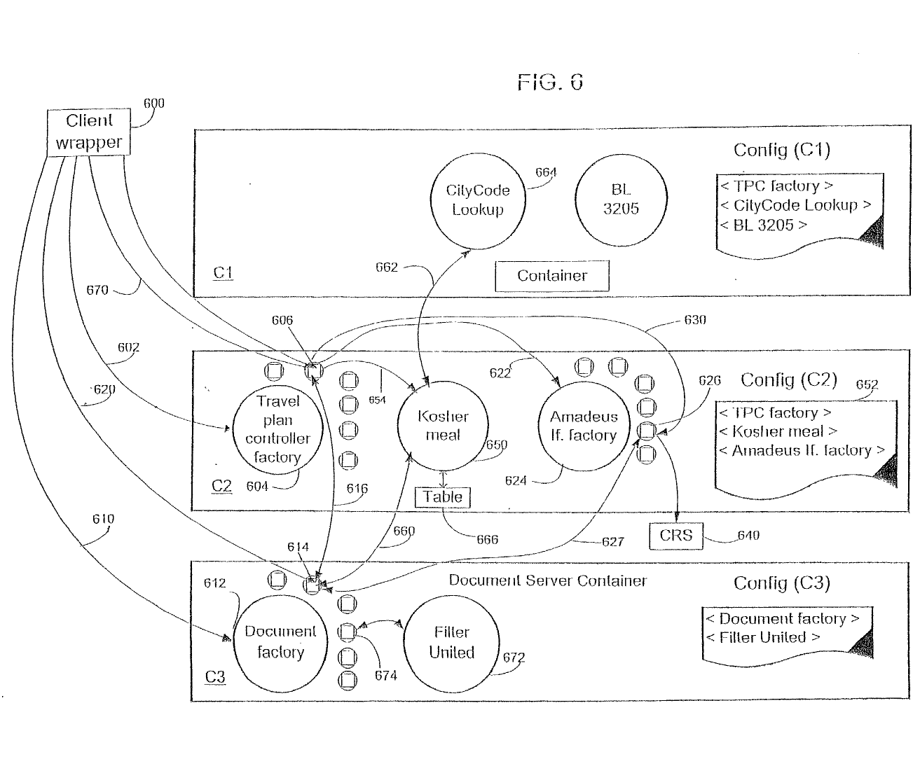

FIG. 5A presents a simple example of a container process C1 and corresponding configuration file “Config(C1)”. Container 500 includes a travel plan controller component 502, a kosher meal component 504 and any other business logic component “XX” 506. FIG. 5B illustrates a second container process 510 that includes the components 502 and 504 previously mentioned, and introduces a new component, Amadeus Interface Factory 512. The interface factory creates interface objects as necessary, illustrated by interface objects 514. The Interface Factory component is added to the container by listing it in the corresponding configuration file “Config.(C2)”. These configuration files are simplified for purposes of illustration and in practical application would contain more details such as those of FIGS. 4A-4B. FIG. 5C illustrates another container process C3, in this example a document server container. This container includes two components, namely a document server component 520 and a Filter United component 516, as listed in the corresponding configuration file “Config. (C3)”. The document server creates individual document objects as necessary, for example, objects (or “documents”) 522 and 524.

In the travel site application, a document will be created for each end-user “session” handled by the Web site application server. The application server maintains session state information, and calls on the document server (the document factory) to generate a new document, and conversely, it can notify the document container to discard a given document when the corresponding session is concluded. The individual document objects store user/session information, such as a flight itinerary, in an XML format as further described later.

FIG. 6 illustrates operation of the software system described above. Referring now to FIG. 6, at the beginning of a client session on the travel planning Web site, the application server (see FIG. 1), using the client wrapper interface 600, makes a call 602 to a travel plan controller factory component 604 shown in container C2. This is essentially a request for the factory to create a travel plan controller instance 606. This object 606 will implement the travel planning process for this particular session. The client wrapper 600 also is used to make a call 610 to a document factory 612, in this case, located in a document server container C3. The document factory 612 creates document objects, in this example, document object 614, for storing information associated with this current session. The corresponding travel plan controller 606 communicates with the document 614 via path 616.

Assume that the end-user in the current session requests information about flights between given locations on a specified date, etc. This flight request information is written to the session document 614 via call 620 in an XML syntax. The travel plan controller (TPC) 606 makes a call 622 to the Amadeus IF Factory 624 to request an interface to the CRS. The factory 624 creates (or assigns from a pool) an interface object IF 626 as requested, i.e., makes it available to the TPC.

IF 626 reads the flight request information 627 from the document 614 using a query language explained later, and creates a flight schedule request in suitable form to present the flight schedule request to the computer reservation system 640. The IF receives a flight schedule response and writes that information into the document 614, again formatted into an XML Syntax. The client wrapper 600 can read the updated document via another call, and provide this information to the application server which, in turn, provides the flight information to the Web server (See FIG. 1). Note that the client wrapper layer provides an interface to the document for the application server to access XML data.

We next assume that the end-user selects her itinerary from among the flights offered. The selected flight information is written to the session document 614 through the client wrapper as described. Before the session is concluded, various business logic components may be called to modify and/or validate travel plan information as appropriate. These other components can be called by the travel plan controller for this session (606), and they will interact with the data stored in the corresponding document 614. Numerous components can be implemented to provide a variety of business logic, as mentioned above, such as pricing, seating assignments, special fares on discounts, mileage club, accommodations and even food requests. We illustrate this last feature by way of a kosher meal business logic component 650. The kosher meal component is shown deployed in container C2 and therefore appears in the corresponding configuration file 652.

The kosher meal component is to determine whether or not kosher meals are available on a flight requested by the end-user. For example, if a kosher meal is requested, the travel plan controller makes a call 654 to the kosher meal component 650. Component 650's job is to determine whether kosher meals are available on the flight segments requested. Two requirements must be satisfied: first, the departure city must be equipped to provide kosher meals; and second, a minimum number of days of advance notice is necessary to provide kosher meals. The number of days of advance notice required will be passed to the kosher meal component, via the configuration file C2, at run time as further explained later. In response to the call 654, the kosher meal component 650 makes a query 660 to the document 614. To determine, for each flight segment, two pieces of information; namely, the departure date and the departure city code. The kosher meal component 650 then makes a call 662 to a CityCodeLookup component 664 to determine whether the departure city indicated is capable of providing kosher meals. We assume this information is available to the CityCodeLookup, as it would have information about virtually all the commercial airports in the world. If kosher meals are available at the indicated departure city, and if the prior notice requirement is met, in terms of the number of days from ticketing (or the current date) to the departure date, the kosher meal component 650 will modify the document 614 to indicate that a kosher meal is available on the corresponding flight segment. This process can be repeated for each flight segment on the itinerary. The kosher meal availability could be implemented with a Lookup table 666, but utilizing the city code lookup component would be preferred so that airport information is collected in one place. Travel plan controller 606 can provide this updated information to the client wrapper 670.

Of course, many other user sessions can be processed at the same time. The application server, via the client wrapper, will request travel plan controllers as necessary and corresponding documents from the document factory. In the figure BL-205 merely identifies another business logic component. Another component, illustrated in container C3, is a filter component called “Filter United” 672. The component framework includes a generic operation called filter. This is used to modify a document that the system is working on. It essentially examines the document and deletes certain information. In this case, Filter United has the task of removing from the document United Airlines flights that appear in the flight schedule response data. To add any new filter, the programmer can simply write one, derived from the base filter class, and add it into the list of filters in the configuration file. For illustration, we show the Filter United updating a document 674.

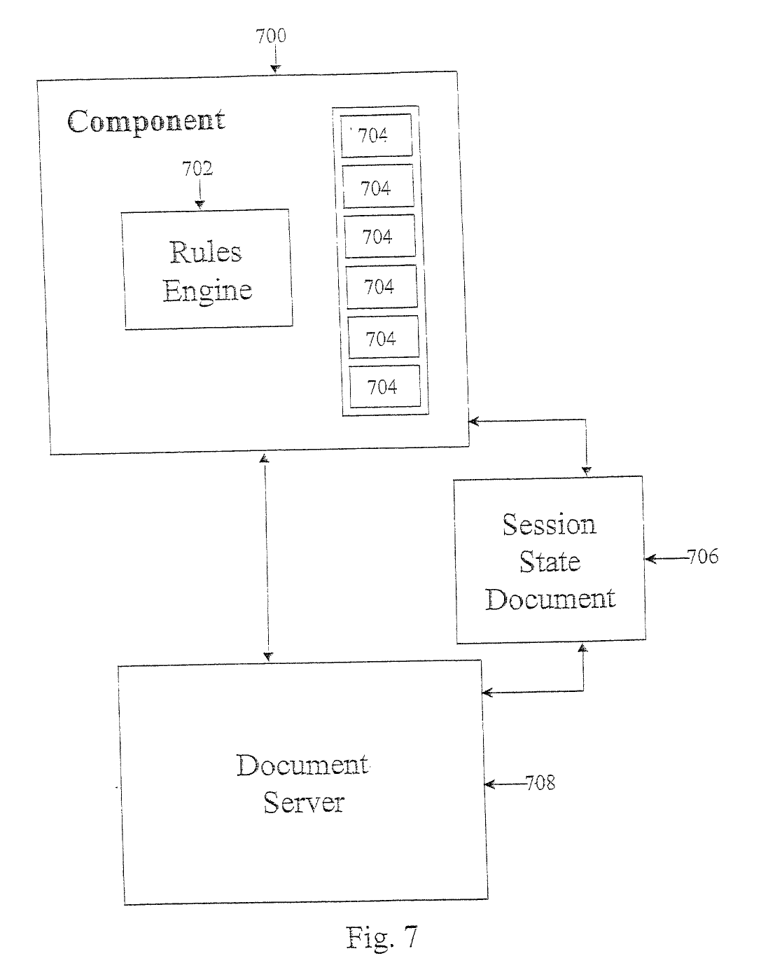

FIG. 7 is a diagram of the elements of a software component 700 including a Rules Engine 702, a set of functions 704 that can be performed by software component 700 and the interactions of software component 700 with a session state document 706 (which corresponds to a configuration file as described above) obtained from a document server 708. With reference to FIG. 7, software component 700 is a typical component in accordance with the present invention. Software component 700 includes a Rules Engine 702 which is operable to read a predetermined rule set (not shown) from session state document 706. The predetermined rule set allows the behavior of software component 700 to be modified without changing any of the code for component 700. Rules Engine 702 retrieves a script (not shown) from session state document 706. The script includes one or more rule sets, as described below, for controlling the behavior of component 700. Rules Engine 702 can make internal calls to any function 704 based on the rule set. This allows customization of the system because the rule sets can be written so as to use one, some, or all of functions 704. Rules Engine 702 is typically the base class of all components in the system and includes a kickoff function as follows:

virtual bool processRules(

SnSFramework_ErrorStore &error,

const SnSWString &sRuleSet,

const SnSWString &sRuleLabel,

const SnSWString &sSpecialInstructions,

SnSFramework_Document_ptr inDocument,

SnSFramework_DocumentNodeId inNodeId,

SnSFramework_Document_ptr outDocument,

SnSFramework_DocumentNodeId outNodeId);

A configuration file as described above may also be used as session state document 706, or in the alternative session state document 706 may be a separate document that has been obtained from document server 708.

In accordance with the present invention the configuration file (session state document 706), as described above, will include a rule set, typically in XML syntax. The different types of information used in scripting a particular predetermined rule set are typically specified by a tree of XML elements, or nodes, with the predetermined rule set as the root node of the tree. All rules within the tree are typically applied by descending through the tree, i.e. processing a first rule child of the predetermined rule set, then the first rule child's children, if any, and moving on to a second rule child of the predetermined rule set, then the second rule child's children, if any, and so on until the component stops.

If a specific rule, within a predetermined rule set, needs to be processed, such as when a component's general purpose method has an operation parameter, for example a Controller component's do_operation, then that rule should be passed into Rules Engine 702 as a label. Rules Engine 702 will then select a matching rule from the predetermined rule set whose name matches the value passed in as the operation parameter, and process only the matching rule and any rule children of the matching rule. For example, a specialized Validator's (not shown) validate method, which takes no Operation parameter, could be implemented to primarily process a labeled rule, calling any other labeled rules only as runtime decisions dictate, much like subroutines. On the other hand, a specialized Controller (not shown) whose do_operation method only performs one operation may not necessarily require a named rule, and may simply process all rule children of its predetermined rule set.

Rules Engine 702 in accordance with the present invention is typically operable to process eight different rule types, which in a presently prefered emobodiment are all written as different XML elements. The eight rule types, along with a brief description of each are as follows:

1) RuleSet: which facilitates making runtime decisions to apply different rules to different situations within the same component;

2) Instruction: which performs a callback into the component to perform a particular piece of functionality;

3) Resource: which provides a way to identify what to pass into a callback;

4) Process: which encapsulates a set of children rules into a group, enabling more than one to be called by a single name, and provides some looping and scoping functionality;

5) Variable: which allows a string value to be associated with a name, either by listing the value as a literal or determining it via a document query;

6) Acquire: which facilitates the obtaining of a Resource (such as a GatewayIF or a document), for use in later rules processing;

7) Release: which provides the ability to explicitly clean up a given resource; and

8) Component: which makes calls against components of a specified type (e.g. Converters, Validators, Modifiers, or Controllers) in a named list or in a single resource.

Each of the above rule types has a number of attributes, some optional and some required, that specify exactly what the rule is and how it must be applied. Throughout this detailed description an asterisk (*) in a heading indicates that an attribute is used by multiple rules and works the same way in every rule. A string sign ($) in a heading indicates an attribute where the attribute value can be replaced by a variable.

<RuleSet Name=“SomeRuleSetName” [Default=“False ”, “True”]>Children Rules </RuleSet>

A predetermined rule set, or node, encapsulates a set of rules that govern the processes and behavior of an individual component. Only one rule set needs to be listed in order for a component to be scripted. However, more than one can be listed, in which case the rule set to be applied is chosen each time Rules Engine 702 is invoked. If Rules Engine 702 is passed the name of a predetermined rule set, it searches for the predetermined rule set with that name, and if found Rules Engine 702 will process that predetermined rule set—or Rules Engine 702 will return an error if that predetermined rule set is not found. If the name passed in is blank, Rules Engine 702 will use a default rule set, if one exists, or, if only one rule set exists, will use that one. If there are multiple rule sets, no default is specified, and the name passed in is blank, an error will result.

Each component 700 uses its own individual settings to determine the name of a predetermined rule set name to pass to Rules Engine 702. Typically, however, the general standard is to begin by looking within the sSpecialInstructions string for RuleSet=“SomeRuleSetName”. If found, component 700 will use this value. If the predetermined rule set was not specified in sSpecialInstructions, the next step is to look in the document context specified in the documentIn parameter for a /Application/RuleSet node. If a /Application/Ruleset node is found, then component 700 will use the node's text value to identify the predetermined rule set. If not found, then predetermined rule set name passed into Rules Engine 702 will be blank.

Alternatively, an optional Default attribute can be used to select a single predetermined rule set as being the default for a particular software system in accordance with the present invention. Listing more than one predetermined rule set as the default for a single software system will cause an error.

<Instruction [Label =“SomeLabel”]Name=“SomeInstruction”

[OnFail=“Ignore ”,“Continue”, “Stop”, “Next”, “ExampleLabel”]>Resource Rules

</Instruction>

Instruction performs a callback into the component within which Rules Engine 702 is currently processing. This is a general purpose callback used to instruct the component to perform some piece of functionality.

The function called is:

virtual bool processinstruction(

SnSFramework_ErrorStore &error,

const SnSWString &sInstruction,

const SnSWString &sSpecialInstructions,

list<SnSResource *, allocator>&resourceList,

SnSVariableMap &variableMap);

The resourceList parameter contains any resources identified by the corresponding rule's Resource children. The variableMap parameter contains all name/value pairs identified so far by Variable rules in the current Process or above, including any that are global to the predetermined rule set.

Label=“SomeLabel”

An optional label attribute can be used to allow jumps directly to a rule, either as an sOperation parameter to a Controller or a GatewayIFController's do_operation call (i.e. the first call into Rules Engine 702), or as the OnFail destination of another rule. All labels within a predetermined rule set must be unique, as in a presently preffered embodiment there are no scoping restrictions enforced within the software system. Once the processing of a rule is complete, control is returned to either 1) a rule that called said rule, or 2) to a component that called said rule.

Name=“SomeInstruction”

A Name attribute specifies which instruction a rule should perform. The value of the Name attribute must be an instruction that the component will understand. Each component implementation defines the set of commands it will accept—consult individual component documentation for the list and definitions of these instructions.

(SomeLabel Only)

OnFail=“Ignore”, “Continue”, “Stop”, “Next”, “SomeLabel”

An OnFail attribute gives the scripter control over how Rules Engine 702 will react, and therefore how rule processing will proceed, when an individual rule fails. The OnFail attribute of an individual rule controls only the flow within the current process. The OnFail attribute cannot entirely stop Rules Engine 702, but can stop the processing of any sibling rules that follow the failed rule. In other words, if a nested Process is stopped by one of its children with a OnFail value of Stop, any rules that follow that nested Process may still be executed (assuming the Process rule's OnFail value is not set to Stop as well.)

1. OnFail Rules:

Ignore

If OnFail is omitted from a rule, then Ignore is the default value. Ignore will cause Rules Engine 702 to process further rules, even if a rule fails. It is important to note that the parent process rule will be considered to fail when it is complete. It will not simply stop when encountering a rule that lists Ignore as its OnFail value.

Continue

Continue is similar to Ignore, in that it will not stop Rules Engine 702 when a rule fails. However, a note is made of the failure of the rule, and a subsequent rule that has an OnFail value of Stop will be considered to fail if any previous rules with OnFail values of Continue have failed, even if it succeeds. This can be useful in situations where two rules must always be processed successively, but should stop if either one fails.

Stop

Stop causes the current Process to be halted. No further siblings will be processed by the Rules Engine.

Next

Next can be used within a Process looping because its Query has identified multiple nodes. If a rule that has an OnFail value of Next fails, no further siblings will be processed for the current node, but subsequent nodes in the query results will still be processed.

SomeLabel

If an OnFail value is not one of the above, it is considered to be a Label. If a rule having an OnFail value that is considered a label fails, then Rules Engine 702 will search the predetermined rule set for a rule that matches the OnFail value and execute the rule that matches the OnFail value. Once the rule that matches the OnFail value is complete, the calling rule will be re-evaluated as if its OnFail value were Stop, using the success or fail value returned by the labeled rule.

<Resource ResourceKey=“someUniqueResourceName”

[FailIfNone=“False”, “True”]/>

A Resource rule is only meaningful as a child of an Instruction, Component, or Acquire rule. It is used to specify how many resources (0 to many) to pass into a callback function as a resourceList parameter.

Most resources must have been obtained by a previous Acquire rule. The exception to this are the InDocument and OutDocument resources, which are reserved resources mapped to the documents passed into the processRules call. The document references within these resources don't change within a single Rules Engine processing. The node IDs depend on the nodes currently being processed, which are only changed by a query in a Process rule.

The resources are put in the list in the exact order they are listed, which can be very important in determining how the component uses the resources: which resources are required, which are optional, and how they are used are dependent on the specific Instruction (Name), Component (ComponentType), or Acquire (ResourceType) that is being processed and how the component handles that situation.

ResourceKey $

ResourceKey=“someUniqueResourceName”

A ResourceKey is used to identify the resource to add to the list being passed to a callback. Unless the resource is an InDocument or OutDocument resource, the name of the resource must exactly match that of a ResourceKey acquired in the execution of a previous Acquire rule.

FailIfNone

FailIfNone=“False”, “True”

A FailIfNone attribute is set to control whether the inability to find a matching resource will be considered as an error.

Process

<Process [Label=“SomeLabel”][Query=“.”, “SomeQuery”]

[Document=“InDocument”, “OutDocument”, “SomeDocumentResource”]

[SeparateThreads=“False”, “True”][ReleaseResources=“False”, “True”]

[OnFail=“Ignore”, “Continue”, “Stop”, “Next”, “ExampleLabel”]>Children Rules </Process>

A Process rule identifies a group of rules to process together. This is most useful as a way to jump to a sequence of rules while using only a single Label, or as a way to loop through the results of a query.

Query $

Query=“.”, “SomeQuery”

If a Query is listed within the <Process> element, a query will be performed on the InDocument at the current document context, and each first level node returned from the query will be processed in a separate pass through the child rules, in sequential order. If no Query is listed, then the current node is processed through a single pass.

Document $

(SomeDocumentResourceKey only)

Document=“InDocument ”, “OutDocument ”, “SomeDocumentResourceKey”

By default a query is performed on the InDocument. If a Document attribute is listed for the Process, the query can be set to perform on the InDocument or OutDocument by using the values InDocument or OutDocument, respectively. The query can also be performed on a document resource that has been acquired at some point, by specifying that document's resourceKey. If the current node is being processed (i.e. there is no Query attribute listed for this Process) this attribute is disregarded even if specified.

SeparateThreads

SeparateThreads=“False”, “True”

If SeparateThreads is listed with a value of True, each pass is executed on a newly allocated thread, all of which are joined at the end of the process. This is especially useful when the children rules include potentially lengthy calls to other components, as they can be executed in parallel. Any children with OnFail values of Stop will only stop their pass, i.e. any other threads will continue through their rules as normal. Any children with OnFail values of Next will be treated as if they are Stop.

ReleaseResources

ReleaseResources=“False ” “True”

If a ReleaseResources parameter has a value of True, then any resources obtained by Acquire rules within the Process are released at its conclusion.

Variable

<Variable[Label=“SomeLabel”]Name=“SomeVariableName”

[ValueType=“Literal”“Query”]

[Document=“InDocument”, “OutDocument”, “SomeDocumentResourceKey”]

[OnFail=“Ignore”, “Continue”, “Stop”, “Next”, “ExampleLabel”]>SomeValue

</Variable>

A Variable rule establishes a name/value pair that will be passed to all sibling or sibling's child <Instruction> elements. It can also be used to replace portions of rule attribute values, such as ResourceKeys. Once defined, a Variable is valid for all subsequent rules, including children of Process rules, both nested and jumped to. Once the current process is exited, however, the variable is removed and it is no longer valid.

Using the ${variable} Format

A portion of a rule attribute value can be replaced by a variable by using an opening string character ($) to signal the use of a variable followed by the variable name enclosed in curvy braces ({variableName} ). For example:

<Variable Name=“GatewayID” ValueType=“Literal”>2</Variable>

<Acquire ResourceType=“GatewayIF” From=“GatewayIFFactory” ResourceKey=“${GatewayID}” OnFail=“Stop”/>

is equivalent to:

<Acquire ResourceType=“GatewayIF” From=“GatewayIFFactory”

ResourceKey=“2” OnFail=“Stop”/>

This is not applicable to all rule attributes. Throughout this document, the attributes to which this is applies are marked with a string sign ($) after their header.

Of course, care should be taken when using variables in an attribute that the resulting value makes sense. If a variable was used to specify an OnFail jump but matched no Label, for example, it would cause an error. Use of variables in complex ways (such as in naming other variables) will slow down processing somewhat. Gratuitous use of variables is likely to result in slow performance.

Variables in Component Callbacks

The other place variable values are used is within the component callback functions. Each callback takes an SnSVariableMap as one of its parameters. This class has the function:

bool getValue(

SnSFramework_ErrorStore &error,

const SnSWString &sVariableName,

SnSWString &sVariableValue)

which provides access to the variable values to the component doing the processing.

Name $

Name=“SomeVariableName”

A Name attribute specifies the variable's name. This is the string associated with the value in the variableMap, and can be used to replace a portion of an attribute value. A variable's name should be unique. If a Variable rule is given a name that is already in use at the current scope level or above, then the attribute value will be permanently overwritten.Value Type

ValueType =“Literal”, “Query”

If a ValueType is set to Literal (the default) then the value of the node is set as the variable's value verbatim. If the ValueType it is set to Query, then the node's value is treated as a document query, and the variable's value is set to the query's result. This query can identify a node or an attribute. In both cases, however, it must identify a single value. A Query that identifies multiple values will cause the software system to produce an error.

Document $

(SomeDocumentResourceKey only)

Document=“InDocumentIn”, “OutDocument”, “SomeDocumentResourceKey”

If a Document value is obtained as the result of a query—as opposed to a predetermined literal value, then by default the qerry will look to an in document to determine the document value. If a Document attribute is listed, this can be controlled to be on the Indocument or an Outdocument, as desired, by assigning Document to equal the values In or Out, respectively. The Document value can also be on a document resource that has been acquired at some point, by specifying that document's resource key. If however, the value type for the Document Value is set to Literal, then this attribute is disregarded even if specified.

Acquire

<Acquire [Label=“SomeLabel”]

ResourceType=“Document”, “GatewayIF”, “SomeResourceType”

ResourceKey=“someUniqueResourceName”[Instruction=“SomeInstruction”]

[OnFail=“Ignore”, “Continue”, “Stop”, “Next”, “ExampleLabel”]>Resource Rules

</Acquire>

Acquire is the method by which a resource is obtained.

SnSResource Data Structure

A resource is any derivative of the SnSResource structure, which looks like:

class SnSResource
{
public:
SnSWString sResourceType;
SnSWString sResourceKey;
virtual ^{˜}SnSResource() { };
};

Callbacks

When a component has a need to acquire and use some resource type, it should define the structure it needs, derived from SnSResource and with the necessary cleanup or release code built into an overridden destructor. They provide the ability within the acquire callback to new the resource, and provide the ability within the callbacks that use the resource to recognize the resource type and cast the SnSResource type down to the correct type and use it. There are two types defined by SnSComponent_i. These are:

class SnSDocumentResource : SnSResource
{
public:
SnSFramework_Document_var varDocument;
SnSFrameworkDocumentNodeId_currentNodeId;
SnSFramework_Factory_var varDocumentFactory;
virtual ^{˜}SnSResource();
}

and:

class SnSGatewayIFResource : SnSResource
{
public:
SnSFramework_GatewayIF_var varGatewayIF;
SnSFramework_Factory_var varGatewayIFFactory;
virtual ^{˜}SnSResource();
}

A SnSResource_i derivative structure need not contain any CORBA references. It is perfectly valid to define a structure containing only normal C++ types or classes. However, care must be taken to ensure that the destructor does everything it needs to do in order to properly clean up when the Rules Engine 702 deletes it; this includes releasing a CORBA component to its factory and/or decrementing a CORBA reference's reference count.

The callback function called by Rules Engine 702 to enable component 700 to acquire or create a necessary resource, is:

virtual bool acquireResource(

SnSFramework_ErrorStore &error,

const SnSWString &sResourceType,

const SnSWString &sResourceKey,

const SnSWString &sInstruction,

const SnSWString &sSpecialInstructions,

list <SnSResource*, allocator>&resourceList,

SnSVariableMap &variableMap,

SnSResource *& pNewResource);

Resources are not scoped in any way. Not only are they global to a rule processing, they are global to Rules Engine 702 itself. If not released at the end of a Process, they will remain in Rules Engine 702 until explicitly freed or for the life of the component. Therefore, resources can be shared between completely different calls into Rules Engine 702. A high degree of care should be taken when programming and configuring a component that doesn't release resources within a single call and/or uses resources and handles multiple simultaneous requests.

In addition, resources needed during the acquisition (e.g. a factory resource, or a data resource) can be passed into the acquireResource call by specifying them as children of the Acquire rule.

ResourceType $

ResourceType=“Document”, “GatewayIF”, “SomeResourceType”

ResourceType is a required attribute. Any type recognized by component 700 is valid for that component. It is component 700's responsibility to ensure the SnSResource pointers are cast down to the proper type at a later time.

ResourceKey $

ResourceKey=“someUniqueResourceName”

ResourceKey is a unique name used to identify the resource. Keys must unique for all resources, i.e. you cannot use the same key for different resource types. This key will be used in future rules to identify the resource to use in certain situations. Component 700 is not responsible for setting this variable in the SnSResource structure. Rules Engine 702 will set this upon return from the acquireResource function.

Instruction $

Instruction=“SomeInstruction”

This attribute should contain any data necessary for component 700 to perform the requested acquisition. An example of such information would be the name of the list from which to get a Factory (not shown) to use in obtaining the component. This is completely type and component implementation dependent.

Release

<Release [Label=“SomeLabel”]ResourceKey=“All”, “SomeUniqueResourceName”

[OnFail “Ignore”, “Continue”, “Stop”, “Next”, “ExampleLabel”]/>

Release can be used to explicitly free a specific resource.

ReleaseKey $

ResourceKey=“All”, “SomeUniqueResourceName”

If the ResourceKey value is “All”, every resource within Rules Engine 702 will be freed. Otherwise, the value must be the key of the resource to release.

Component

<Component [Label=“SomeLabel”] ComponentType=“Converter”, “Validator”, “Modifier”, “Controller”, “GatewayIFController”, “SomeOtherComponentType” Name=“SomeComponentListName” [RuleSet=“SomeRuleSet”,“ ”]

[Instruction=“SomeInstruction”]

[SpecialInstructions=“SomeSpecialInstructions”][FailIfNone=“False”, “True”]

[OnFail=“Ignore”, “Continue”, “Stop”, “Next”, “ExampleLabel”]>Resource Rules

</Component>

A component rule (not

shown) tells Rules Engine 702 to make CORBA calls against each component in a predetermined list of components. Rules Engine 702 itself does not call the component operation, instead Rules Engine 702 makes a call to a callback function in the parent component, which handles the actual searching for the predetermined list of components, traversing of the predetermined list of components, and the individual calls to the various component within the predetermined list of components. This function is:

virtual bool SnSComponent_i::callComponents(

SnSFramework_ErrorStore &error,

const SnSWString &sComponentType,

const SnSWString &sComponentName,

const SnSWString &sInstruction,

const SnSWString &sSpecialInstructions,

bool bFailIfNone,

list<SnSResource*, allocator>resourceList,

SnSVariableMap &variableMap);

The Resource Rules children of a Component rule are used to control which resources are passed in to callComponents. These will often include document resources. If no resource children are listed, the InDocument and OutDocument resources are passed, in that order.

ComponentType $

ComponentType=“Converter”, “Validator”, “Modifier”,

“Controller ”, “GatewayIFValidator, “GatewayIFModifier”,

“GatewayIFController ”, “SomeOtherComponentType”

The ComponentType attribute contains the type of the component to call. The operation will be the general-purpose function of the type selected (e.g. Validator's validate, Modifier's modify, etc.). The values listed above are all the types supported by SnSComponent_i, except for the last value, which represents any type that a class that derives from SnSComponent_i chooses to add.

Name $

Name=“SomeComponentListName”

The Name attribute contains the value of the predetermined list of components to use. If the list will be searched for in the appropriate map, depending on the component type (e.g. if the type is Validator, the ValidateMap will be searched).

RuleSet $

RuleSet=“SomeRuleSet”

This optional parameter provides control over the RuleSet that a destination component will apply if the destination component is scripted. If listed, the RuleSet instruction is written in to the sSpecialInstructions string. If a RuleSet instruction is already present, its value will be overridden. Otherwise, it is appended to the string.

Instruction $

Instruction=“SomeInstruction”

This attribute should contain any data necessary for a component to perform a requested component call. This is completely type and component implementation dependent.

SpecialInstructions $

SpecialInstructions=“SomeSpecialInstructions”

If listed, this attribute's value is appended to the sSpecialInstructions string for a component call. This parameter provides a limited ability to script special instructions; these special instructions cannot be overridden or removed. However, new special instructions can be added. The software system will not check to ensure that there are no duplicate instructions.

FailIfNone

FailIfNone=“False”, “True”

If no matching component list is found, or if the list contains no components, a FailIfNone attribute controls whether or not the software system will treat the lack of a matching component as an error.

Sample XML

The following is a simple example of the configuration XML for a validator that uses rule scripting:

<Component Name=“BkCarAvailabilityValidator”>

<Creator Name=“BkCarAvailabilityValidatorCreator” Library=“/libBkCarAvailabilityValidatorCreators.so”/>

<RuleSet Name=“Test” Default=“True”>

<Variable Name=“MaxFutureDays”

ValueType=“Literal”>362</Variable>

<Process Label=“Validate” ReleaseResources=“True”>

<Acquire ResourceType=“BkCarAvailabilityRentalInfo”

ResourceKey=“MyStore” OnFail=“Ignore”>

<Resource ResourceKey=“InDocument”

FailIfNone =“True”/>

</Acquire>

<Instruction Name=“ValidDates” OnFail=“TestJump”>

<Resource ResourceKey =“MyStore”

FailIfNone =“True”/>

</Instruction>

<Instruction Name=“MaxFutureDays”

OnFail=“Continue”>

<Resource ResourceKey=“MyStore”

FailIfNone=“True”/>

</Instruction>

</Process>

</RuleSet>

</Component>

For example, a video chain, having a plurality of video stores, and using a software system in accordance with the present invention is running multiple concurrent promotions for their customers. A first promotion provides for giving a free video rental coupon to any customer that has rented ten or more movies in the previous thirty days. As a means of encouraging the customer to return to the store the free video rental coupon is typically mailed to the customer, even though the customer is notified at the time of rental. If however, the customer is considered a “valued” customer, the first promotion provides for giving the valued customer a free video rental coupon if the valued customer has rented five movies in the previous thirty days and the valued customer received the coupon at the time of rental. Typically the video chain has three levels of customer status: normal, valued, and star. Status may be determined by frequency of rentals or any of a wide variety of predetermined factors. The status of each customer of the video chain is typically stored in a customer database. The second promotion provides for giving a customer a free movie poster for every rental of a predetermined movie within a collection of movies maintained by the video chain.

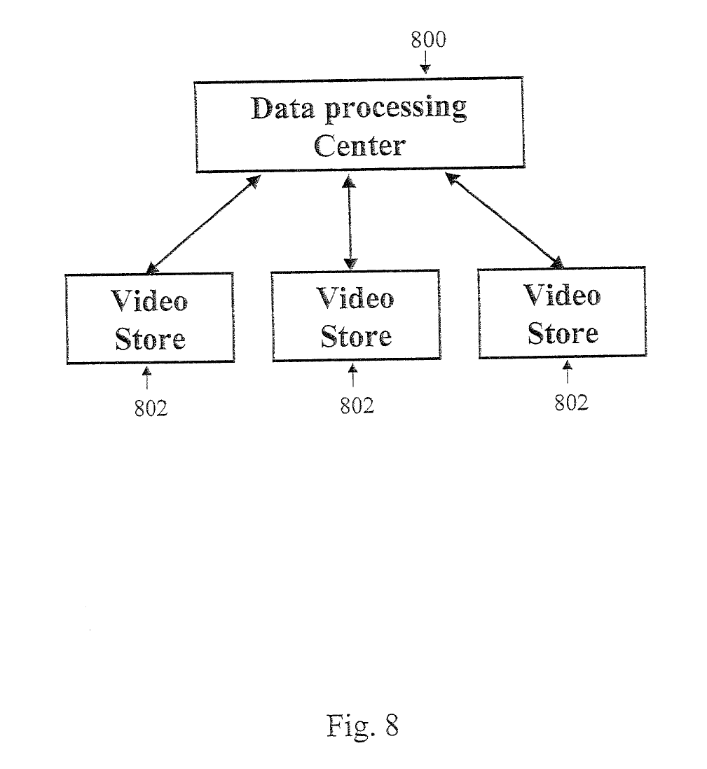

FIG. 8 shows the typical structure for the video chain discussed above having a centralized data processing center 800 and a plurality of video stores 802 each of which interact with data processing center 800. The video chain will typically have a single data processing center 800 that is connected to all of its various video stores 802, either via leased lines a wide area network or the Internet. Data processing center 800 is responsible for recording a rental transaction in a proprietary internal system, and for determining if the rental qualifies for any of the above referenced promotions. For example, if the rental qualifies for a free video rental coupon via mail, then a message is returned to the video store 802 telling an employee the video store 802 to let the customer know a coupon is on the way. Alternatively, if the rental qualifies for a free video rental coupon at the time of rental, then a message is returned to the video store 802 telling an employee of the video store 802 to give the customer a free video rental coupon. Likewise, if the rental qualifies for a free movie poster, a message is returned to the video store 802 telling an employee of the video store 802 to give the customer a free movie poster. All promotions that occur are recorded in an internal system.

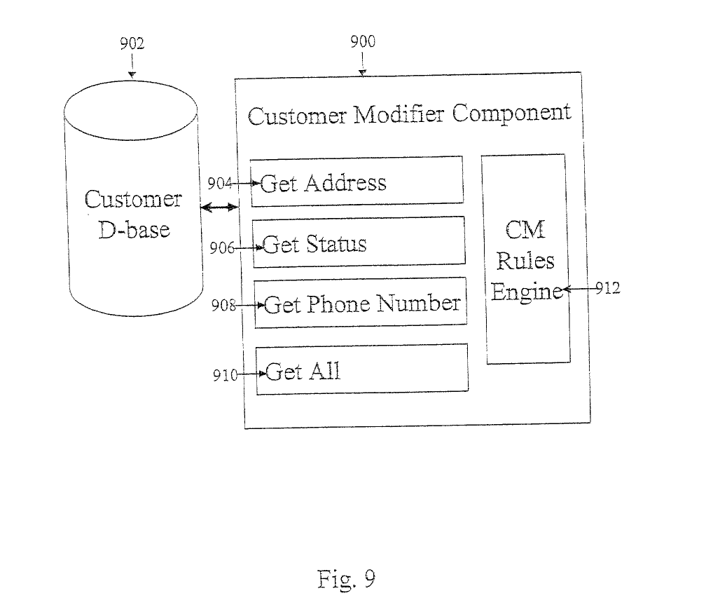

In the present example, data processing center 800's middle-ware solution is based on a software system in accordance with the present invention. The middle-ware includes a plurality of flexible components, as described above, that can be used for promotions and various other needs. For example, one such component may be a CustomerModifier component 900, as shown in FIG. 9. With reference to FIG. 9, CustomerModifier component 900 is responsible for looking up a Customer ID (not shown) in customer database 902, and generating XML data for a user of the system with information such as the Customer's address, status, and phone number. Since not all this information is needed all the time, in a presently preferred embodiment CustomerModifier component 900 is broken up into multiple independent instructions such as GetAddress 904, GetStatus 906, GetPhoneNumber 908, and GetAll 910 . The multiple independent instructions can be scripted so that all the information about a customer is returned, or just an individual piece, or some combination of individual pieces of information. A CM Rules Engine 912 allows CustomerModifier component 900 to be scripted as described above with reference to FIG. 7.

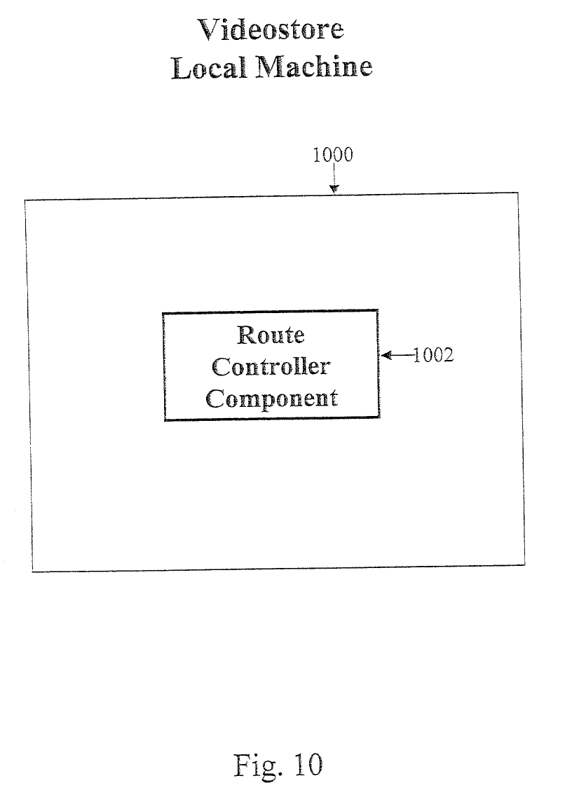

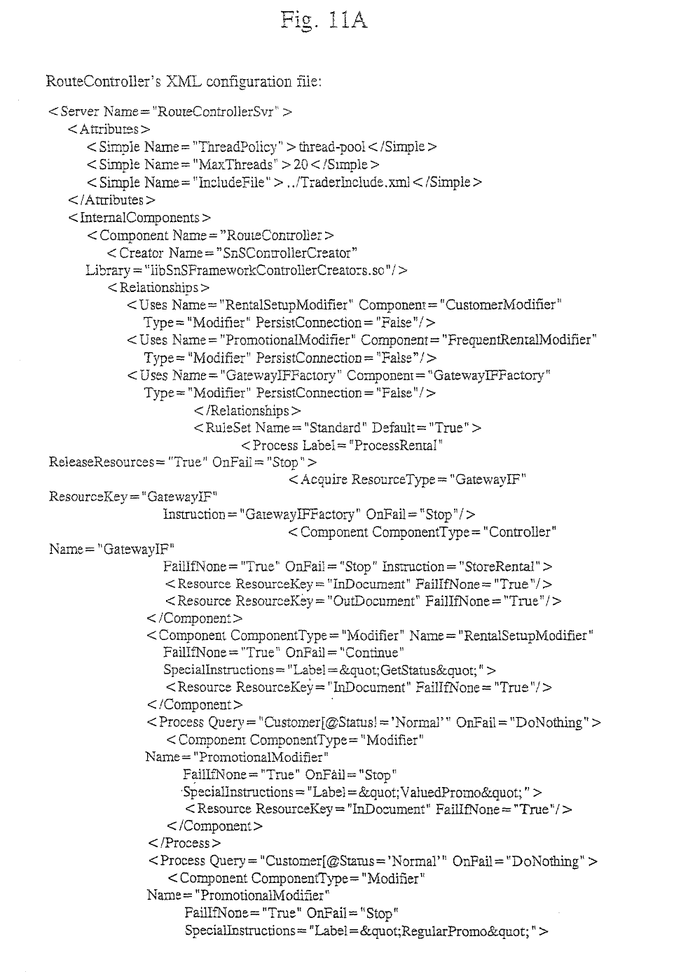

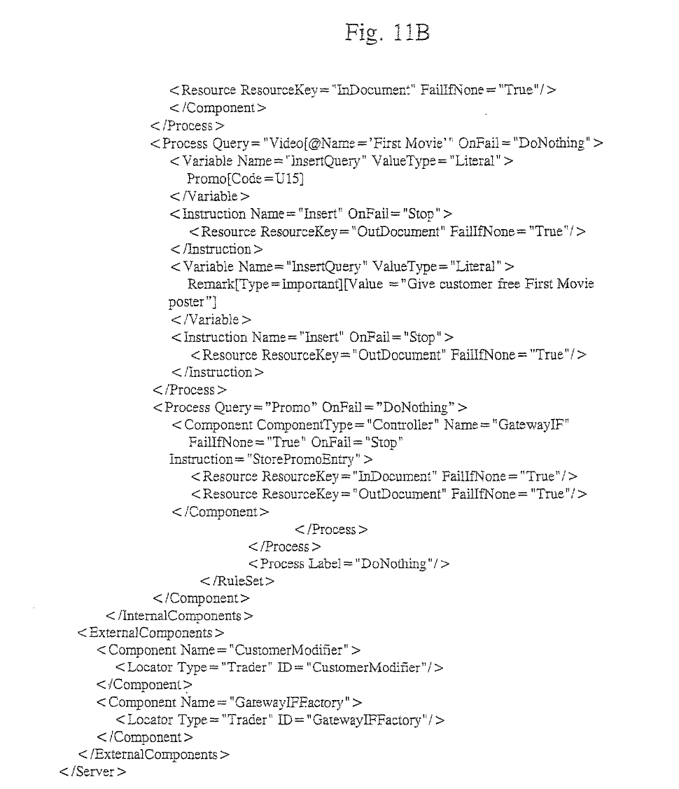

FIG. 10 is a block diagram showing a local computer 1000 at one of video stores 802. Typically local computer 1000 will include a client application (not shown) for locally processing video rentals. The client application is configured to work with a middle ware solution as described generally above and in more detail below. Typically the client application will include a RouteController component 1002, which will handle all interaction with the middle ware solution as described below. FIG. 11A and 11B is a configuration file for RouteController component 1002, written in XML syntax.

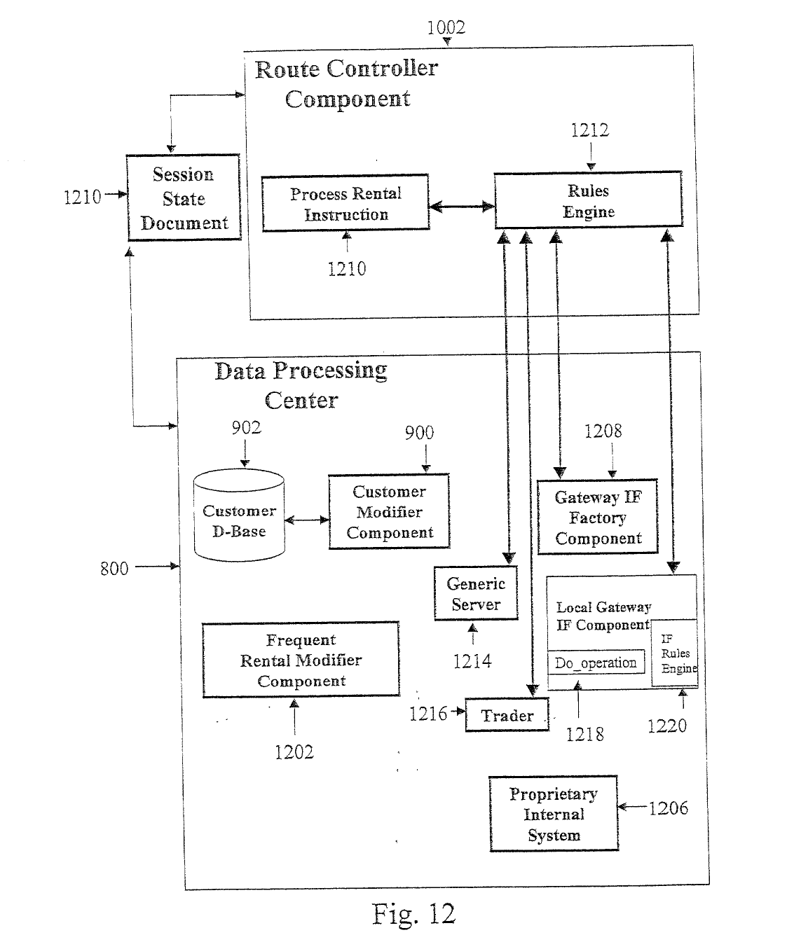

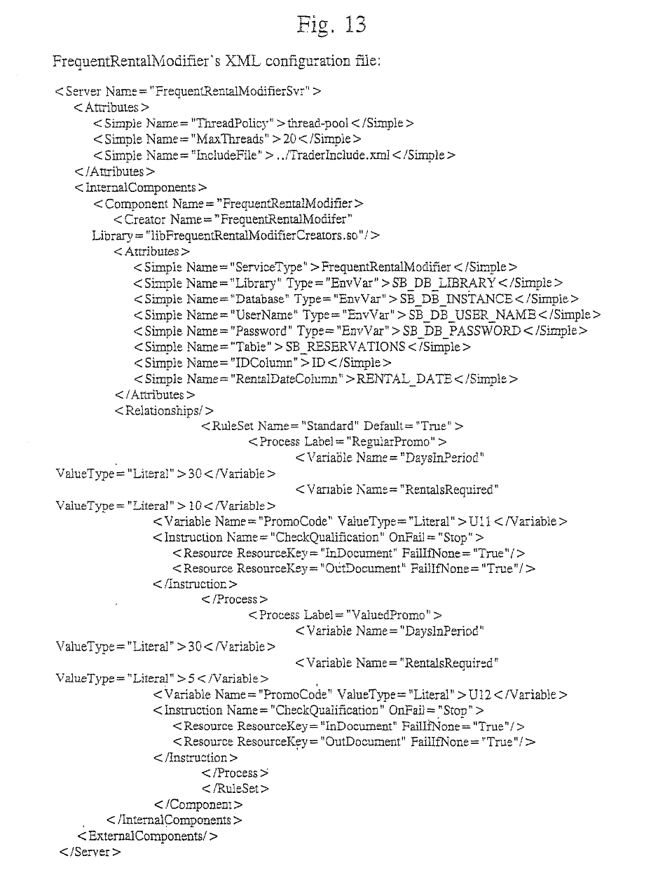

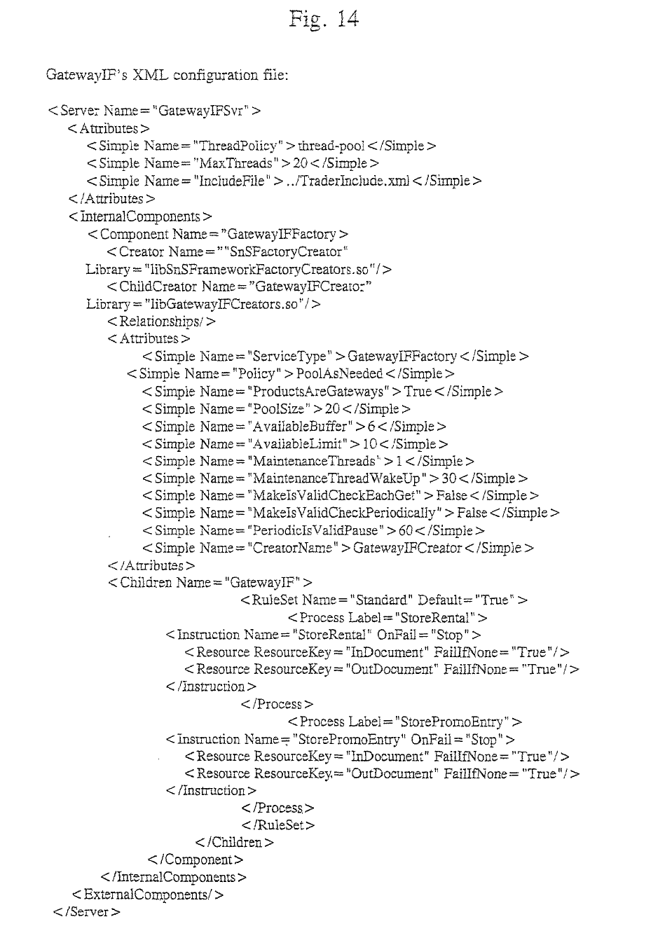

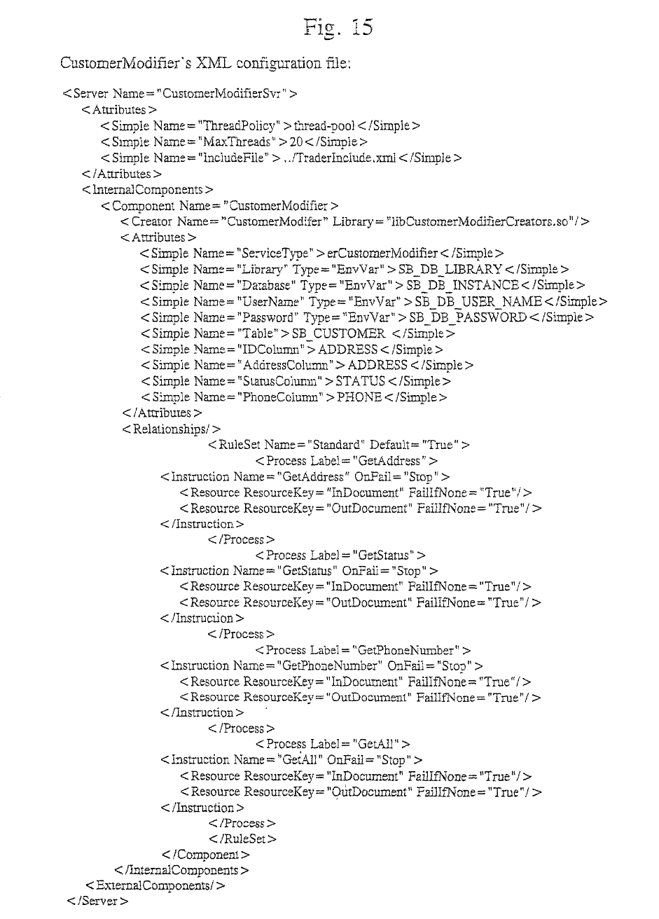

FIG. 12 shows the details of data processing center 800 and RouteController component 1002 in greater detail, along with interactions between data processing center 800 and RouteController component 1002. With reference to FIG. 12, another typical component in the middle ware system is a FrequentRenterModifier component 1202. FrequentRenterModifier component 1202 will typically be responsible for looking up rental information about a particular customer. Based on configurable values, FrequentRenterModifier component 1202 can determine if a customer has rented X number of movies in Y number of days. In the example above FrequentRenterModifier component 1202 would be configured to recognize either ten movies in thirty days or five movies in thirty days. The configuration file, in XML syntax, for FrequentRenterModifier component 1202 is shown in FIG. 13 Again with reference to FIG. 12, an additional typical component is a local GatewayIF component 1204. Local GatewayIF component 1204 will typically be responsible for storing transactions against the video store's proprietary internal system 1206. All video rentals as well as promotional transactions will be recorded in the video chain's proprietary internal system 1206. In some cases, local GatewayIF component 1204 will maintain state with the video chain's proprietary internal system. For example, some transactions for a single session are split across multiple calls to local GatewayIF component 1204. As a result, this component is typically managed by a GatewayIF Factory component 1208. A configuration file, in XML syntax, for local GatewayIF component 1204 is shown in FIG. 14.

Refering back to FIG. 12, a first customer (not shown) visits a video store within the video chain and rents two movies. Upon renting the movie, the following XML State Data is created and sent to RouteController component 1002 along with an instruction called “ProcessRental” instruction 1210, which in a presently preferred embodiment may be as follows:

<VideoRental>

<Video Name=“First Movie” Category=“Comedy”ID=“34242334267343”>

<Due Date=“11212001”/>

</Video>

<Video Name=“Second Movie” Category=“Action”ID=“44343247343”>

<Due Date=“11212001”/>

</Video>

<Customer ID=“43243247”>

<Name Title =“Mr” FirstName=“First” LastName=“Customer”/>

</Customer>

<Payment Type=“Cash” Value=“7.85”/>

</VideoRental>

ProcessRental instruction 1210 must first acquire a component that it locally calls local GatewayIF component 1204. The script tells a Rules Engine 1212 of RouteController component 1002, that local GatewayIF component 1204 is a GatewayIF type component and that it can be acquired from a Factory called GatewayIFFactory 1208. Rules engine 1212 asks a GenericServer 1214 for information about GatewayIFFactory 1208 and discovers that it should ask a trader 1216 for the information. Rules Engine 1212 contacts trader 1216 and asks for an object reference to GatewayIFFactory 1208, which is returned to it by trader 1216. Rules Engine 1212 then makes a get_component call (not shown) on GatewayIFFactory 1208 and receives back an object reference to local GatewayIF component 1204.

The next instruction tells Rules Engine 1212 to make a call to a do_operation method 1218 on local GatewayIF component 1204, and passing “StoreRental” into do_operation method 1218 as the instruction name. In accordance with the present invention Rules Engine 1212 of RouteController component 1002 makes the call, and an IF Rules Engine 1220 in local GatewayIF component 1204 takes over. IF Rules Engine 1220, of GatewayIF component 1204 then jumps to the “StoreRental” label, and makes an internal call on local GatewayIF component 1204. The internal call gets the information it needs from an XML session state document 1230 and stores it in the Rental Chain's internal system. The process completes and control returns to ProcessRental instruction 1210 of RouteController component 1002. If an error occurred during the call to local GatewayIF component 1204, the script would stop, release local GatewayIF component 1204 back to GatewayIFFactory 1208 and return to the calling component. Otherwise, the script for ProcessRental instruction 1210 will continue.

The next instruction tells Rules Engine 1212 to make a call on all modifiers associated with a RentalSetupModifier name. Rules Engine 1212 looks the name up and discovers that a single component is associated with that relationship name and that component is called CustomerModifier component 900, whose configuration file, in XML syntax is shown in FIG. 15. Referring back to FIG. 12, Rules Engine 1212 asks GenericServer 1214 for information about CustomerModifier component 900 and discovers that it should ask trader 1216 for it. Rules Engine 1212 then contacts trader 1216 and asks for an object reference to CustomerModifier component 900, which it gets as a return value from trader 1216. It then calls a modify method of CustomerModifier component 900 and passes GetStatus into CustomerModifier component 900 as a SpecialInstructions parameter. Rules Engine 1212 makes the call, and a CM Rules Engine 912 in CustomerModifier component 900 takes over, and jumps to a “GetStatus” label in the script, and makes an internal call on CustomerModifier component 900. The internal call gets a CustomerID value from XML session state document 1230 and looks up the customer status in a database table specified in its configuration, i.e. it looks in the STATUS column of the CUSTOMER table. CustomerModifier component 900 then updates the Customer XML element, within XML session state document 1230 with the proper Status value. The First customer happens have a value of “Star”. The process completes and control returns to ProcessRental instruction 1210 of RouteController component 1002. The XML in session state document 1230 after this step is in part as follows:

<VideoRental>

<Video Name=“First Movie” Category=“Comedy” ID=“34242334267343”>

<Due Date=“11212001”/>

</Video>

<Video Name=“Second Movie” Category=“Action” ID=“44343247343”>

<Due Date=“11212001”/>

</Video>

<Customer ID=“43243247” Status=“Star”>

<Name Title=“Mr” FirstName=“First” LastName=“Customer”/>

</Customer>

<Payment Type=“Cash” Value=“7.85”/>

</VideoRental>

If an error occurred during the call to CustomerModifier component 900 the script would stop, causing Rules Engine 1212 of RouteController component 1002 to release local GatewayIF component 1204 back to GatewayIF factory 1208 and return to the caller. Otherwise, the script for ProcessRental instruction 1210 will continue. Furthermore, if there were other components associated with the relationship RentalSetupModifier, those other components would be called next by RouteController component 1002.

The next instruction tells Rules Engine 1212 of RouteController component 1002 to issue a document query and see if there are any Customer elements in the XML whose Status attribute was not equal to Normal. If so (as in this case), the scripting engine asks GenericServer 1214 for components associated with the “PromotionalModifier”, discovers it should ask trader 1216 for a FrequentRentalModifier component 1202 , gets an object reference for FrequentRentalModifier component 1202 , and makes a call to a modify process (not shown) of FrequentRentalModifier component 1202. ValuedPromo is passed in as a SpecialInstructions parameter if Status was not equal to Normal; otherwise, RegularPromo is passed in as a SpecialInstructions parameter in the chunk of script that gets called next. Rules Engine 1212 of RouteController component 1002 makes the call to FrequentRentalModifier component 1202, and a FRM Rules Engine (not shown) in the FrequentRentalModifier component 1202 takes over, jumps to the proper label (“RegularPromo” or “ValuedPromo”) in the script, and makes an internal call on the a CheckQualification instruction (not shown) in FrequentRentalModifier component 1202. Three variables are also passed that the CheckQualification instruction uses: DaysInPeriod (number of days in past to consider), RentalsRequired (the number of rentals required in that time period to qualify), and PromoCode (the code to use if qualified). The CheckQualification instruction looks at the database (based on information in its configuration file) and sees if First Customer qualifies for a promotion. In this case, First Customer did qualify and an XML element is added to session state document 1230 by FRM Rules Engine of FrequentRentalModifier component 1202 to indicate this. The process completes and control returns to ProcessRental instruction 1210 of RouteController component 1002. The XML in session state document 1230 after this step is in part as follows:

<VideoRental>

<Video Name=“First Movie”Category=“Comedy” ID=“34242334267343”>

<Due Date=“11212001”/>

</Video>

<Video Name=“Second Movie” Category=“Action” ID=“44343247343”>

<Due Date=“11212001”>

</Video>

<Customer ID=“43243247” Status=“Star”>

<Name Title=“Mr” FirstName=“First” LastName=“Customer”/>

</Customer>

<Payment Type=“Cash” Value=“7.85”/>

<Promo Code=“12U”/>

<Remark Type=“Important” Message=“Give customer free rental coupon”/>

</VideoRental>

If an error occurred during the CustomerModifier call, the script would stop, release local GatewayIF component 1204 back to GatewayIF factory 1208 and return to the caller. Otherwise, the script for ProcessRental continues. Typically, a check for Customer's with Normal Status would occur next, however that has already been described above.

The next instruction tells the script engine to issue a Document query and see if First Movie is one of the Videos First Customer is renting. If First Movie is one of the videos, Rules Engine 1212 makes a number of document calls to add more promotional information to the XML in session state document 1230. The XML in session state document 1230 after this step is in part as follows:

<VideoRental>

<Video Name=“First Movie” Category=“Comedy” ID=“34242334267343”>

<Due Date=“11212001”>

</Video>

<Video Name=“Second Movie” Category=“Action” ID=“44343247343”>

<Due Date=“11212001”/>

</Video>

<Customer ID=“43243247” Status=“Star”>

<Name Title=“Mr” FirstName=“First” LastName=“Customer”/>

</Customer>

<Payment Type “Cash” Value “7.85”/>

<Promo Code=“12U”/>

<Remark Type “Important” Message=“Give customer free rental coupon”/>

<Promo Code=“U25”/>

<Remark Type=“Important” Message=“Give customer free First Movie poster”/>

</VideoRental>

If an error occurred during the insertion process, the script would stop, release the local GatewayIF 1204 back to GatewayIF factory 1208 and return to the caller. Otherwise, the script for ProcessRental instruction 1210 continues.

The next instruction tells Rules Engine 1212 of RouteController component 1002 to issue a Document query and see if there are any Promo elements in the XML. If so, the next instruction tells the script engine to make a call to local GatewayIF 1204's do_operation method 1218 passing “StorePromoEntry” as the instruction name. Rules Engine 1212 of RouteController component 1002 makes the call, and IF Rules Engine 1220 of local GatewayIF component 1204 takes over, jumps to the “StorePromoEntry” label, and makes an internal call on the component. The internal call gets the information it needs from the XML in session state document 1230 and stores it in proprietary internal system 1206. The process completes and control returns to ProcessRental instruction 1210 of RouteController component 1002.

ProcessRental instruction 1210 is now complete. Before returning, it looks to see if its ReleaseResources attribute is “True”. Since it is, it release local GatewayIF component 1204 back to GatewayIFFactory 1208 and lets go off any object references to either component. It then returns true.

It will be obvious to those having skill in the art that many changes may be made to the details of the above-described embodiment of this invention without departing from the underlying principles thereof. The scope of the present invention should, therefore, be determined only by the following claims.

1. A scripting method for controlling process flow and configuration in a distributed object-oriented software system, the method comprising:
providing a plurality of software components at least one of which is derived from a common base class and arranged for operation in the distributed software system;
providing an executable general container process;
creating a configuration file readable by the general container process for configuring the container process and including therein identification of at least one of the said software components;
in the general container process, reading the configuration file at run time and loading the software components identified in the configuration file for subsequent execution; and
further providing at least one rule set associated with one of the identified software components derived from the common base class for controlling process flow during execution of the corresponding component, responsive to run time conditions, without having to modify the component source code.

2. A scripting method according to claim 1 wherein the rule set is included within the configuration file.

3. A scripting method according to claim 2 wherein the configuration file is expressed in XML syntax.

4. A scripting method according to claim 3 wherein the common base class includes a rules engine that implements a predetermined rules-based scripting language, the rules engine including methods for selecting and executing the rule set.

5. A scripting method according to claim 4 wherein the rules engine implements a callback function for calling a selected one of the loaded software components to perform a predetermined function.

6. A scripting method according to claim 4 wherein the rules engine is arranged to receive a reference and to pass the reference to a component in connection with a callback to identify a resource to the called component.

7. A scripting method according to claim 4 wherein the rules engine implements a process rule type which encapsulates a selected set of children rules into a group for calling such group by a single name.

8. A scripting method according to claim 4 wherein the rules engine implements a Component rule type which makes calls automatically against all components of a specified type.

9. A scripting method according to claim 4 wherein the rules engine implements a Variable rule type which allows a string value to be associated with a name.

10. A distributed, object-oriented software system for enabling a user to script its own specific business logic without modifying the system source code, the system comprising:
a plurality of software components at least one of which is derived from a common base class and arranged for operation in the distributed software system;
a general container process for loading and executing selected ones of the said software components; and
a configuration file readable by the general container process and including therein identification of at least one of the said software components for loading and execution;
wherein the common base class includes a rules engine that implements a predetermined rules-based scripting language; and
wherein the configuration file includes at least one rule set consistent with the scripting language and associated with one of the identified software components derived from the common base class for realizing the user's specific business logic during execution of the corresponding component without having to modify the component source code.

11. A software system according to claim 10 wherein the scripting language implements at least one rule type selected from the following:
a RuleSet rule type to make a runtime selection among multiple rule sets within a single component;
an Instruction rule type that makes a callback into the associated component to perform a predetermined function;
a Resource rule type providing identification of data/argument to pass into a callback;
a Process rule type which encapsulates a selected set of children rules into a group, thereby enabling more than one of such rules to be called by a single name;
a Variable rule type which allows a string value to be associated with a name;
an Acquire rule type to facilitate obtaining a selected Resource for use in later rules processing;
a Release rule type to explicitly de-allocate memory previously allocated to a selected resource; and
a Component rule type which makes calls against components of a specified type.

12. A rules based scripting language for use in a distributed object oriented software system, wherein a software component of the software system is adapted to interpret and implement the scripting language, comprising:
a RuleSet rule type that instructs the component to make a runtime selection among multiple rule sets within the component;
an Instruction rule type that instructs the component to make a callback into the component to perform a predetermined function;
a Resource rule type that provides the component with identification of data/argument to pass into a callback;
a Process rule type which instructs the component to handle a selected set of children rules as a group, thereby enabling more than one of such rules to be called by a single name;
a Variable rule type which instructs the component to allow a string value to be associated with a name;
an Acquire rule type which instructs the component to obtain a selected Resource for use in later rules processing;
a Release rule type which instructs the component to explicitly de-allocate memory previously allocated to a selected resource; and
a Component rule type which instructs the component to make calls against other components of a specified type.
